(19) United States
(12) Patent Application Publication
(10) Pub. No.: US 2005/0076846 A1
(43) Pub. Date: Apr. 14, 2005

(54) Apparatus for scooping and sifting cat litter

(76) Inventors: Steven Tsengas, Fairport Harbor, OH (US); Judith L. Casstevens, Madison, OH (US)

Correspondence Address: Law Offices of John D. Gugliotta, PE, Esq., 202 Delaware Building, 137 South Main Street, Akron, OH, 44308, US

(21) Appl. No.: 10/963,953

(22) Filed: Oct. 12, 2004

Related U.S. Application Data
(60) Provisional application No. 60/510,575, filed on Oct. 14, 2003.

(51) Int. Cl. A01K 1/035

(52) U.S. Cl. 119/166

(57) ABSTRACT

An apparatus for scooping and sifting cat litter is provided having a handle depending from an enclosure. The handle is tapered to provide a comfortable and easily used handle for grasping and using the scoop. The enclosure is significantly wider than the handle, thus providing sufficient space for the placement of wasted cat litter clumps therein. The enclosure includes a mouth permitting ingress and egress of waster cat litter clumps and excess cat litter. The enclosure also includes a solid portion and a grated portion. The grate portion includes a plurality of slots and a plurality of ribs alternately placed therebetween. The slots permit excess cat litter to filter therethrough.

### RELATED APPLICATIONS

The present invention claims the benefit of U.S. Provisional Patent No. 60/510,575, dated Oct. 14, 2003, and incorporated by reference herein.

### BACKGROUND OF THE INVENTION

Scooping apparatuses designed for extracting cat litter waste from a cat litter box are presently available in several familiar configurations. Among the most popular are shovel-style scoops with a flat, but grated heads for allowing a user to slide the scoop beneath a cat litter clump and then allowing the excess cat litter to filter through into the cat litter box. Other variations on this theme are common in the art. However, this design configuration suffers from several drawbacks, including poor filtration of the excess cat litter, whereby excess cat litter clings to the scoop and is then deposited in undesired areas, such as floors or carpets, and increases the likelihood of illness, contamination or allergic response. The present invention overcomes this and other drawbacks of the commonly available scoop.

### SUMMARY OF THE INVENTION

It is therefore an object of the present invention to provide an improved cat litter scoop apparatus having an enclosure that includes a solid portion and a grated portion, the grated portion having slots for sifting excess cat litter therethrough.

It is another object of the present invention to provide an improved cat litter scoop that prevents spillage of excess cat litter and degraded cat litter clumps onto carpets and floors.

It is a further feature of the present invention to provide an improved cat litter scoop that is easy to use and ergonomically configured.

Briefly described according to one embodiment of the present invention, a handle depending from an enclosure. In relation to enclosure, the handle is tapered to provide a comfortable and easily used handle for grasping and using the scoop. The enclosure is significantly wider than the handle, thus providing sufficient space for the placement of wasted cat litter clumps therein. The enclosure includes a mouth permitting ingress and egress of waster cat litter clumps and excess cat litter. The enclosure also includes a solid portion and a grated portion. The grate portion includes a plurality of slots and a plurality of ribs alternately placed therebetween. The slots permit excess cat litter to filter therethrough.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a cat litter scoop in accordance with one embodiment of the present invention;

FIG. 2 is a side view of the scoop illustrating the tapered handle, the widened enclosure and mouth, and the divided solid and grated portions thereon;

FIG. 3 is an alternate embodiment of the scoop having an ovally shaped enclosure and mouth; and

FIG. 4 is an alternate embodiment of the scoop having an orthogonally shaped enclosure and mouth.

### DESCRIPTION OF THE PREFERRED EMBODIMENTS

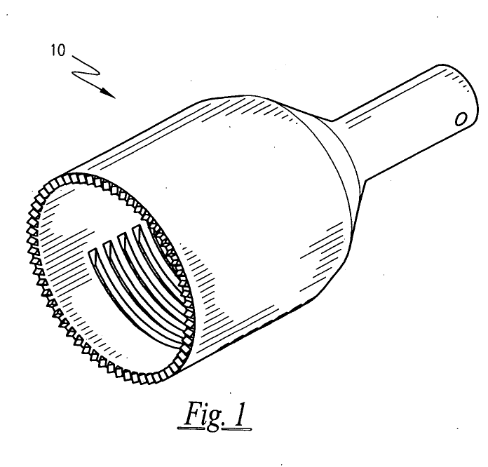

The best mode for carrying out the invention is presented in terms of several preferred embodiments, herein depicted within FIGS. 1 through 4.

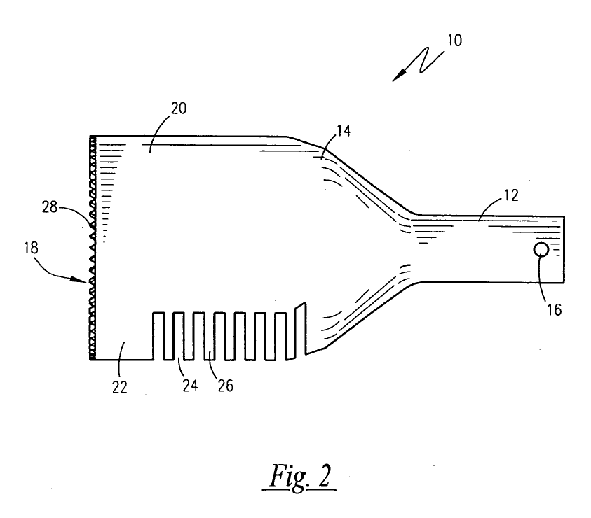

Referring now to FIG. 1 and FIG. 2, a cat litter scoop 10 is shown in accordance with one embodiment of the present invention. The scoop 10 comprises a handle 12 depending from an enclosure 14. In relation to enclosure 14, the handle 12 is tapered to provide a comfortable and easily used handle for grasping and using the scoop 10. The handle 12 may have an ergonomic design, including ridges or protrusions for comfortable spacing of the fingers, thereby reducing any strain or risk of injury that may be present. The handle 12 may also include an aperture 16 for placement on a hook, chain or other similar securing device for hanging and convenient placement near the cat litter box.

The enclosure 14 is significantly wider than the handle 12, thus providing sufficient space for the placement of wasted cat litter clumps therein. The enclosure 14 includes a mouth 18 permitting ingress and egress of waster cat litter clumps and excess cat litter. The enclosure 14 also includes a solid portion 20 and a grated portion 22. The interaction of the solid and grated portions 20 and 22, respectively, are disclosed in further detail below. The grate portion 22 includes a plurality of slots 24 and a plurality of ribs 26 alternately placed therebetween. The ribs 26 separate the slots 24 at a distance, thereby permitting the wasted cat litter clump to rest within the enclosure 14 and allowing the excess cat litter to filter through the slots 24 back into the cat litter box.

Along the outer perimeter of the mouth 18, a plurality of tines 28 are provided so that the remaining cat litter may be raked as desired to expose fresh cat litter or to hide wasted cat litter that may be too fine to extract using the scoop 10.

In operation, the scoop 10 is grasped by the handle 12, with the mouth 18 inserted into the cat litter for ingress of wasted cat litter clump(s), with the grated portion 22 facing downward toward the cat litter. After wasted cat litter clump(s) is/are received by enclosure 14, the excess cat litter is sifted through the plurality of slots 24 and re-deposited back into the existing cat litter. To transport to a predestined waste repository, such as a garbage bag, trash can or toilet, the user will rotate the scoop 10 along the horizontal so that the solid portion 20 is inverted with the grated portion 22 and vice versa, thereby resulting in the grated portion 22 oriented in an upwardly facing direction and the solid portion 20 oriented in a downwardly facing direction. The rotation of the scoop 10 by 180° (as described) traps the wasted cat litter clump(s) within the enclosure 14 during transport and prevents any excess not filtered through the slots 24 from escaping the scoop 10, while also preventing spills of clump particles that may be dislodged during transport. Upon reaching the repository, the scoop 10 is tilted downwardly so that the mouth 18 is pointed toward the repository and the wasted cat litter clump(s) egresses into the repository.

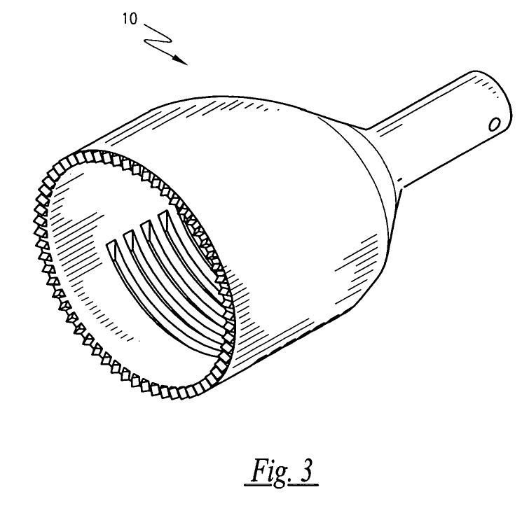

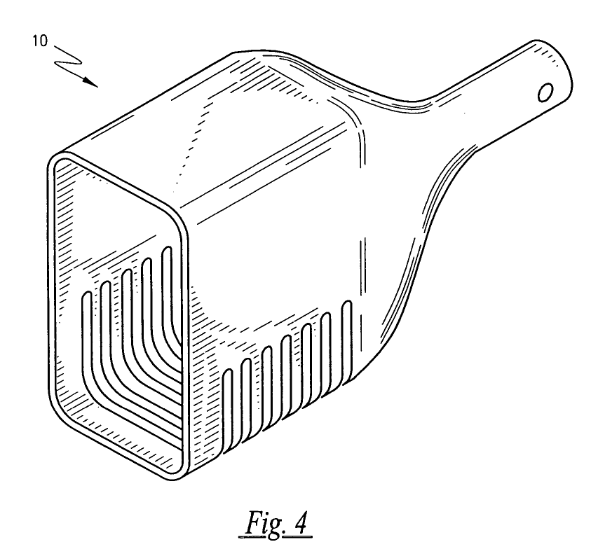

Referring now to FIG. 3 and FIG. 4, alternate embodiments of the enclosure 14 and mouth 18 are depicted, wherein FIG. 3 depicts an oval shaped enclosure 14 and corresponding mouth 18, providing greater space and area than the circular shaped embodiment depicted in FIG. 1 and FIG. 2. FIG. 4 depicts an orthogonally shaped enclosure 14 and corresponding mouth 18, providing greater control to the scoop 10, having harder edges through which control and manipulation are enhanced.

The foregoing descriptions of specific embodiments of the present invention have been presented for purposes of illustration and description and are not intended to be exhaustive or to limit the invention to the precise forms disclosed. Obviously many modifications and variations are possible in light of the above teaching. The embodiments were chosen and described in order to best explain the principles of the invention and its practical application, and enable others skilled in the art to best utilize the invention and various embodiments. It is intended that the scope of the invention be defined by the Claims appended hereto and their equivalents. Therefore, the scope of the invention is to be limited only by the following claims.

1. An improved cat litter scoop apparatus having an enclosure that includes a solid portion and a grated portion, the grated portion having slots for sifting excess cat litter therethrough.

2. An improved cat litter scoop that prevents spillage of excess cat litter and degraded cat litter clumps onto carpets and floors.

3. An improved cat litter scoop comprising:
a handle depending from an enclosure;
said handle depending from said enclosure and tapered to provide a comfortable and easily used handle for grasping and using the scoop;
said enclosure significantly wider than said handle, thus providing sufficient space for the placement of wasted cat litter clumps therein;
a mouth formed at said enclosure opposite of said handle permitting ingress and egress of waster cat litter clumps and excess cat litter;
a grate portion of said enclosure having a plurality of slots and a plurality of ribs alternately placed therebetween, said slots permitting excess cat litter to filter therethrough.
